(19) United States
(12) Patent Application Publication
(10) Pub. No.: US 2010/0326379 A1
(43) Pub. Date: Dec. 30, 2010

(54) Narrow profile horizontally-opposed engine

(76) Inventors: Dana Beall, Williamstown, WV (US); Joe Young, Little Hocking, WV (US)

Correspondence Address: KING & SCHICKLI, PLLC, 247 NORTH BROADWAY, LEXINGTON, KY, 40507, US

(21) Appl. No.: 12/658,242

(22) Filed: Feb. 5, 2010

Related U.S. Application Data
(60) Provisional application No. 61/152,478, filed on Feb. 13, 2009.

(51) Int. Cl. F02B 75/18; F02B 13/00

(52) U.S. Cl. 123/41.74; 123/575

(57) ABSTRACT

An internal combustion engine of boxer design that is capable of running on different types of fuel, including but not limited to gasoline, diesel fuel or ethanol, with the fuel being provided to the engine by an interchangeable cylinder cover is disclosed, and with cylinders that are arranged so as to make the engine narrow-profile and thus smaller and more light-weight than other internal combustion engines.

### BACKGROUND OF THE INVENTION

Prior art includes the standard overhead valve (OHV) engine, a version of which is manufactured by major automobile manufacturers worldwide. The distinguishing features of the present invention are the interchangeability of the cylinder cover that allows the engine to run on different types of fuel, including but not limited to gasoline of various octane ratings, ethanol, and diesel fuel, and the horizontal orientation of the opposing cylinders to each oilier and the valves' and portings' inclusion as part of the cylinder assembly itself that allows for the engine to be smaller and more lightweight than previous engines.

### DETAILED DESCRIPTION OF THE INVENTION

The present invention is an internal combustion engine that is capable of running on different fuel sources at different times, depending upon the cylinder cover that is attached. The engine in the present invention is based upon a reconfiguration of a standard OHV engine and is composed of horizontally-opposed cylinders with interchangeable cylinder covers, a cylinder cooling system, spark plugs, pistons, piston connecting rods, a crank shaft, a timing gear, an intake cam shaft, an exhaust can shaft, a cam lobe, a roller lifter, an intake valve, an exhaust valve, a valve spring, a valve tube, an intake port, an exhaust port, a crank case, a crank case timing cover, a crank case trans-adapter, a crank case top cover, a crank case oil sump, a flywheel, an oil pump, an alternator, an intake manifold, a throttle body, a fuel injector, a fuel rail, an exhaust collector, and an overhead valve engine.

The present invention has an even number of cylinders, including but not limited to 4-cylinder, 6-cylinder and 8-cylinder configurations, arranged in two horizontally-opposed rows. The cylinders to be used in this engine are based upon the cylinder used in a 1917 Gravely tractor motor that was never patented and has not been manufactured since the late 1960's or early 1970's. The major modifications that are to be made to this cylinder enable the axis of air that flows through the engine to be enhanced. This is accomplished by repositioning the engine valves in relation to the top of the cylinder. In the Gravely cylinder, the positioning of the valves is parallel to the bore cylinder and ninety (90) degrees from the crank center line. In the present invention, the positioning of the valves are rolled between five (5) and thirty (30) degrees off of the parallel axis to the bore cylinder, thus allowing for a more effective air flow through the motor, and an additional one (1) to ten (10) degrees from the cylinder bore center line, thus allowing for increased compression ratios configurations. (FIG. 1) This configuration also allows for a more compact engine by allowing the cam shaft to be closer to the crank shaft. (FIG. 2) An intake port is located on one end of each cylinder, with an exhaust port located on the opposite end of said cylinder. (FIG. 4) Each individual cylinder is bolted to the engine case at the base of the cylinder wall to provide a solid mounting that is less affected by thermal expansion. The valves are located in the ports and actuate in the same direction as the piston movement. (FIGS. 1 and 4) Placement of the cylinder between the intake and exhaust valves provides a separation between the valves making a cleaner combustion chamber, and also lowering the incidence of pre-detonation of fuel under heavy loads. (FIG. 4)

The specific cylinder of the Gravely tractor engine must be modified due to the valve configuration in the present invention. (FIGS. 1, 4 and 8) The modification of the Gravely cylinder is accomplished by rolling the valve axes as described above. The materials from which this new cylinder may be cast or manufactured include but are not limited to cast iron aluminum or any type of metal that can be manipulated to the specifications required for the machine to function effectively. Each cylinder is identical allowing cylinders to be added to increase engine displacement making the overall engine less expensive to manufacture.

The cylinder itself can be liquid-cooled or water-cooled. (FIG. 8) A standard air-cooling or liquid-cooling system that is commercially available is contemplated for use in accomplishing the cooling of the cylinder.

Each cylinder is capable of having multiple spark plugs in any amount greater than one (1) because the spark plugs will be attached to the cylinder cover. The spark plugs can be attached by threading into the cylinder cover itself. (FIG. 8) Alternative placements of the spark plugs other than the threading depicted in FIG. 8 are contemplated, and may be employed, depending on the specific intended use of the motor. Intake and exhaust valves are actuated by two separate cam shafts (10 & 11), one located above and one below the crankshaft. Each cam shaft supports a series of cam lobes for opening and closing the valves. (FIG. 2) Each cam lobe is followed by a roller lifter that operates the valve. (FIG. 2) Springs are located between the cylinder and valve to hold the valve closed. (FIGS. 4 and 5) The valve assembly is enclosed in a protective tube which also acts as an oil return. (FIGS. 5 and 7) The crank case halves are split along the axis of the cam shaft and the crank shaft, with bearings laminated between the halves to support the cams and crank, (FIGS. 2, 3 and 6) The engine case provides a mounting base for the modular cylinders as well as the timing cover and trans-adapter. (FIGS. 1, 3 and 7) The crank case oil sump and crank case top cover also bolt to the crank case to provide access to the top and bottom sections of the engine without disassembly of the entire case. (FIGS. 3 and 6)

The cylinder cover is the first of the two key characteristics of the present invention that make the engine novel. Each embodiment of the cylinder cover allows for the engine itself to run on a different type of fuel. There are cylinder covers contemplated for the use of gasoline, diesel fuel and ethanol, and other embodiments are contemplated for types of fuels not listed above as well as any and all future engine fuels that might be introduced to the market. The key feature of each cylinder cover is its interchangeability. The engine itself does not need to be reconfigured to run a different type of fuel; the only step necessary to change the fuel type on which the engine is operating is a changing of the cylinder cover itself. (FIG. 5)

The cylinder cover is capable of being air-cooled or water-cooled. (FIG. 8) A standard air-cooling or liquid cooling system that is commercially available is contemplated for use in accomplishing the cooling of the cylinder cover.

Each cylinder cover has a distinct compression ratio, thus allowing for variable compression ratios to be used on the same engine. The compression ratios that are able to be used in this cylinder cover range from 6:1 to 25:1. This enables the present invention to function effectively on fuels of different types and grades.

The second key characteristic of the present invention is that the engine itself is smaller, narrower and lighter than a standard overhead valve engine. The cylinders are arranged in horizontal opposition to each other, which allows for the construction of a narrow-profile engine, thus making the present invention smaller than previous internal combustion engines. In addition to the small size of the present invention, the engine can also be made more lightweight than other overhead valve engines on the market by manufacturing the crank case out of a heat-resistant polymer rather than metal components. This is not required for the present embodiment to function effectively, but it is a possibility contemplated by the inventors. The valve placement also adds to the narrow profile of the present invention by allowing for the entire engine to be narrower than other overhead valve engines. This will provide the minimal frontal cross-section that is needed for use in aviation and other confined-space applications of the present invention. It is also contemplated by the inventors that this invention will have applications in the automotive industry as well.

The present invention will be more effective at running gasoline that is of a lower octane rating than the standard overhead valve configuration motors because the valves do not transmit heat from one to another due to the distance between the individual valves. It will also be more effective than the standard overhead valve engine at running on other fuels of lower octane and quality.

### BRIEF DESCRIPTION OF THE DRAWINGS

FIG. 1 is a perspective section view of a complete assembly of a four cylinder configuration according to the invention.

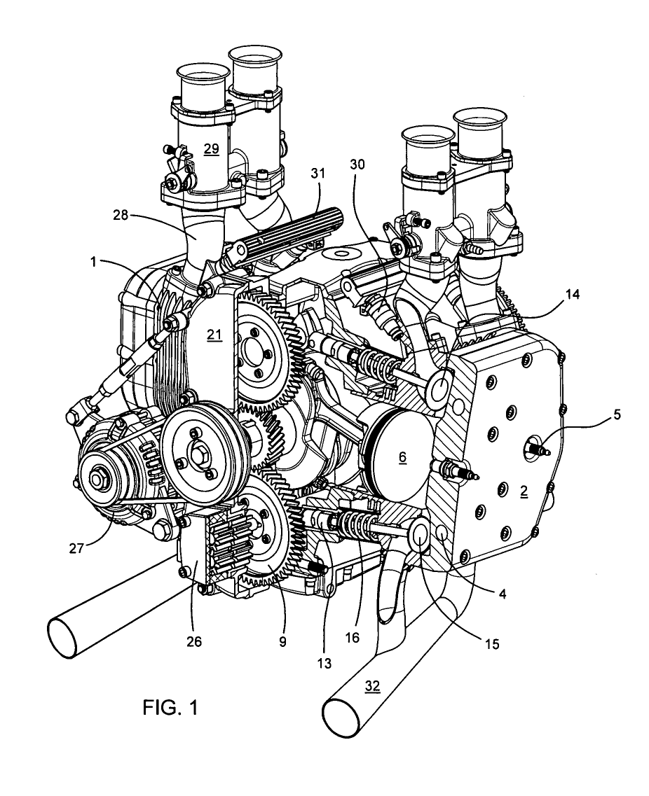

FIG. 2 is a perspective view showing the internal workings and valve configuration.

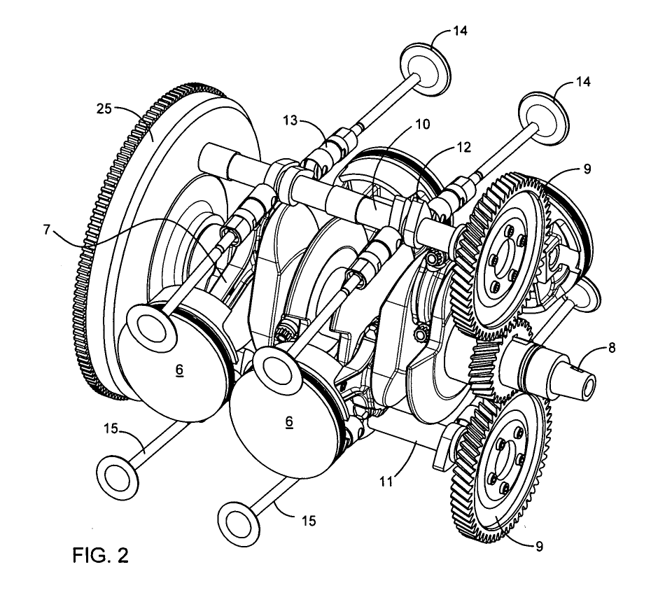

FIG. 3 is a perspective view showing the crank case assembly.

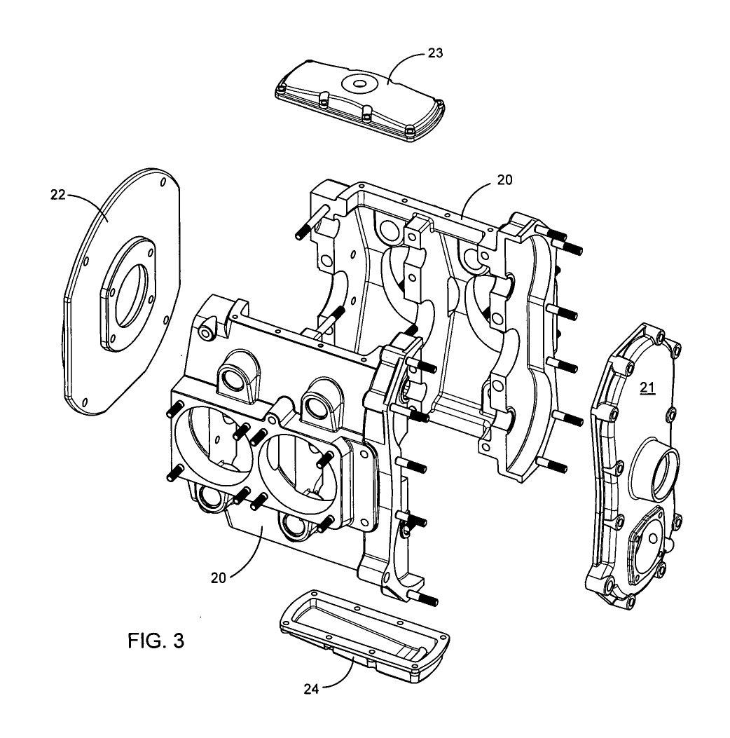

FIG. 4 is a perspective view showing a section view of the modular cylinder assembly.

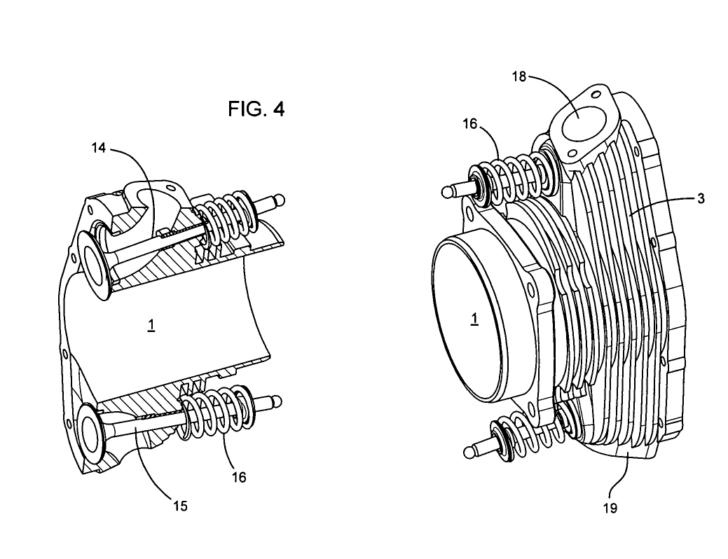

FIG. 5 is an exploded view of the modular cylinder assembly.

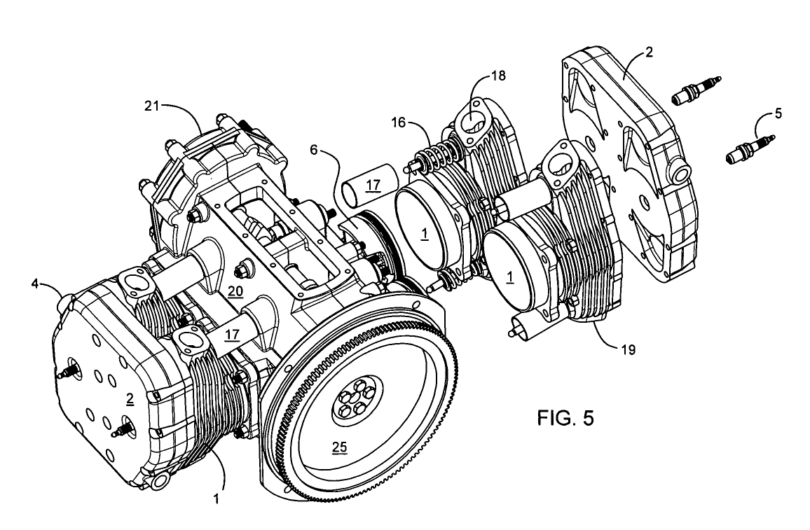

FIG. 6 is a top view of a fully assembled engine with overall sizes as compared to currently available engines of similar displacement.

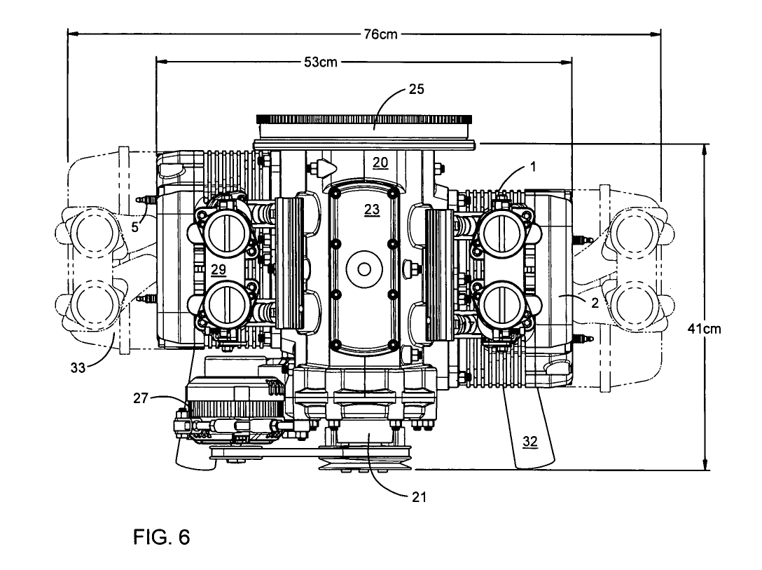

FIG. 7 is a front view of a fully assembled engine with overall sizes as compared to currently available engines of similar displacement.

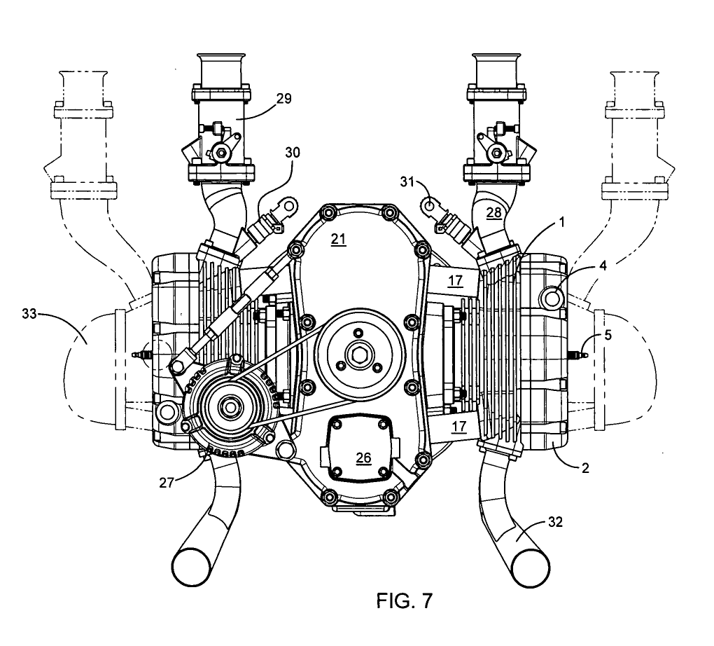

FIG. 8 is a perspective view showing both a liquid-cooled and an air-cooled version of the cylinder assemblies.

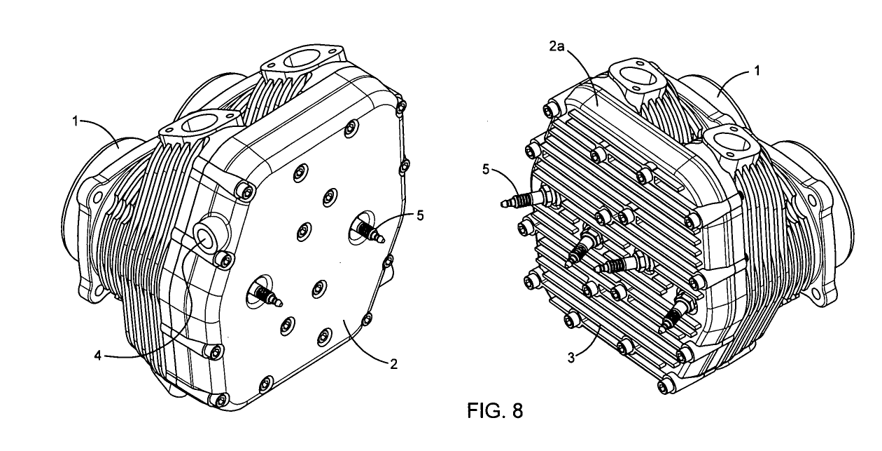

### REFERENCE NUMBERS FOR DRAWINGS

1 Cylinder (air cooled)
1a Cylinder (liquid cooled)
2 Cylinder Cover (liquid cooled)
2a Cylinder Cover (air cooled)
3 Air Cooling Fins
4 Liquid Coolant Channel
5 Spark Plug
6 Piston
7 Piston Connecting Rod
8 Crank Shaft
9 Timing Gear
10 Intake Cam Shaft
11 Exhaust Cam Shaft
12 Cam Lobe
13 Roller Lifter
14 Intake Valve
15 Exhaust Valve
16 Valve Spring
17 Valve Tube
18 Intake Port
19 Exhaust Port
20 Crank Case Half
21 Crank Case Timing Cover
22 Crank Case Trans-Adapter
23 Crank Case Top Cover
24 Crank Case Oil Sump
25 Flywheel
26 Oil Pump
27 Alternator
28 Intake Manifold
29 Throttle Body
30 Fuel Injector
31 Fuel Rail
32 Exhaust Collector
33 Prior art—Over head valuve engine used today.

What is claimed:

1. An internal combustion engine that is capable of running on different fuel sources at different times, depending upon the cylinder cover that is attached to the cylinder, that is composed of horizontally-opposed cylinders, a cylinder cooling system, spark plugs, pistons, piston connecting rods, a crank shaft, a timing gear, an intake cam shaft, an exhaust cam shaft, a cam lobe, a roller lifter, an intake valve, an exhaust valve, a valve spring, a valve tube, an intake port, an exhaust port, a crank case, a crank case timing cover, a crank case trans-adapter, a crank case top cover, a crank case oil sump, a flywheel, an oil pump, an alternator, an intake manifold, a throttle body, a fuel injector, a fuel rail, an exhaust collector, and an overhead valve engine.

2. The engine of claim 1, having a variable, even number of cylinders that are arranged in horizontal oppositional orientation to each other.

3. The engine of claim 1, wherein said cylinder to be used is modified from that of the unpatented Gravely tractor engine cylinder manufactured in 1917.

4. The engine of claim 1, wherein said cylinder is includes intake and exhaust ports on opposite sides of the cylinder, and valves that are located on top of the cylinder, with the positioning of these valves rolled between five (5) and thirty (30) degrees from the parallel line axis to the bore cylinder.

5. The engine of claim 1, wherein said cylinder is capable of being composed of a single material, including but not limited to cast iron or plated aluminum.

6. The engine of claim 1, wherein said interchangeable cylinder covers are each designed to deliver, individually, a different type of fuel to the engine, including, but not limited to, ethanol, diesel fuel, and gasoline of various octane ratings.

7. The engine of claim 1, wherein said cooling unit can either be an air-cooling unit, including but not limited to an air cooling fin and an air-coolant channel that function to cool the engine, or a liquid-cooling unit, including but not limited to liquid cooling jackets that are cast into the cylinder walls and the cylinder head.

8. The engine of claim 1, wherein said oil pump, flywheel, alternator, throttle body, fuel injector, fuel rail, spark plugs, connecting rods, pistons can all be modified from commercially-available technology, depending on the preferences of the builder.
